(19) United States
(12) Patent Application Publication
(10) Pub. No.: US 2011/0271290 A1
(43) Pub. Date: Nov. 3, 2011

(54) METHOD FOR CALLING AN INSTANCE OF A FUNCTION, AND CORRESPONDING DEVICE AND COMPUTER SOFTWARE

(75) Inventor: François Bodin, Rennes (FR)

(73) Assignee: CAPS ENTREPRISE, Rennes (FR)

(21) Appl. No.: 13/126,938

(22) PCT Filed: Oct. 21, 2009
(86) PCT No.: PCT/EP09/63761

§ 371 Date: Jul. 19, 2011

(30) Foreign Application Priority Data
Oct. 30, 2008 (FR) 08/57416

(51) Int. Cl. G06F 9/54; G06F 9/45

(52) U.S. Cl. 719/330; 717/106

(57) ABSTRACT

A method is provided for calling with a processor an instance of a function present within at least a first software module and required by a second software module, referred to as a calling software module. The method further includes that the calling comprises a step of obtaining a current execution context, where the current execution context depends on at least one execution situation of the calling software module, and the current execution context comprises execution data. The method also includes that the calling step comprises a step of selecting the instance of the function, from at least two available instances, depending on the execution data of the current execution context.

### CROSS-REFERENCE TO RELATED APPLICATIONS

This application is a Section 371 National Stage Application of International Application No. PCT/EP2009/063761, filed Oct. 21, 2009 and published as WO 2010/049317 on May 6, 2010, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present disclosure relates to the field of the deployment of software applications.

The present disclosure relates more particularly to a method for calling function in computer applications designed to be executed on hardware platforms that are not homogeneous.

### BACKGROUND OF THE DISCLOSURE

A hardware platform, such as a PC type personal computer, is composed of numerous parts: one or several processors, one or several graphics boards, data connection buses (local series bus, parallel bus), volatile memory management interfaces (RAM) as well as mass storage management interfaces. Whilst respecting substantially identical communication techniques, such hardware platforms may be profoundly different.

In general, computer applications, implemented by an applications code (or program), require increasingly powerful calculations to provide the user with speed and functions. These codes use algorithms which combine sequential and parallel calculation phases of varying complexity.

The use of multi-core architectures, which may be found in many hardware platforms, is based on the use of parallel calculation phases of applications codes. These codes must optimise the use of the hardware resources (components, graphics board, processors and memory) as efficiently as possible regardless of the architecture of the hardware platform in question.

Furthermore, each application must take into account the resources used by the other applications in order to avoid creating a competition that would be detrimental to the overall performances of the system.

In the following description, we will use the term “calculation node” for a set of homogeneous or non-homogeneous multi-core processors organised around a main memory. This memory is not necessarily shared by all of the processors, the data transfers may also be used by the DMA (Direct Memory Access), etc.

Each calculation core may have a dedicated local memory, as is the case for certain multi-core architectures.

Solutions of the Prior Art:

In the common state of the techniques, the performance of an application is influenced by a large number of factors:
the hardware parts available on the calculation node:
   a calculation node is the set of (multi-core or not) processors and the hardware accelerators: for example graphic processing unit (GPU) or field programmable rate arrays (FGPU) which share a common physical memory;
the possible priority given to each application;
the sets of data on which the applications are working;
the applications which are already running and their use of the resources.

In the following description, such factors are grouped together by the expression “execution context”.

Many techniques, especially based on the use in parallel of multi-core architectures aim to resolve such problems. Their objective is to offer maximum performances by optimising the use of the available resources. The difficulties encountered arise, as previously mentioned, from the multitude of different components that may compose a platform and from the fact that the optimum use of these components is not easy.

To enhance the performances, software application compilation techniques have been proposed. They apply two main principles: a static adaptation which allows the application to be conformed to the platform on which it is installed. This static adaptation may be made when the software is installed on the platform. Therefore, during the installation of the application on the computer, the software component in charge of the installation obtains a certain number of parameters from the computer and carries out a compilation, of at least certain components of the application in function of these parameters.

For example, if the installation component has detected that the platform has a graphics board of a certain type, or of a certain brand (NVidia™ or ATI™ for example), then this information is sent to the compiler which then compiles the functions and procedures which use the graphics board in function of these parameters (type of graphic processor, memory available on the board, etc.).

This installation compilation technique during the deployment, has the advantage of providing a set of instances of functions or instances of procedures compiled in function of the platform on which the application is installed, and are therefore adapted to operate with the components of this platform.

It has the disadvantage of not taking into account the execution parameters of the application: when the application is executed, if the graphics board is overloaded and is not able to carry out the processing requested, the fact that the instance of the function which is to carry out the processing is adapted to the component does not change the fact that the performances of the application are downgraded, at least until the graphics board is unloaded. In other words, this technique does not take into account the entire execution context of the application.

Another technique consists of compiling functions or procedures in function of the requirement to generate instances of a function or procedures that are at least partially adapted to the execution context. These techniques creating the instance of the function when it is called.

This technique is called Just In Time (JIT), or also dynamic compilation. When the application is executed, if a function needs to be called, a check is first made that the function has already been compiled, and if there exist is an instance of a function that may be used. If this is not the case, a dynamic compilation is made in function of the parameters collected dynamically to create an executable instance of function. This type of JIT technique is ideal for application debugging operations and to generate code in function of the context (call stack, but independently of the occupation of hardware resources) of the call of the function that is dynamically compiled. Dynamic compilation is not however a technique that may be used, in its common state, for real time applications which require significant resources from the platform on which it is executed. Indeed, even though the original source code of the function to be compiled is not directly used for the compilation (dynamic compilation uses an intermediate code which has been pre-compiled and optimised statically), even so the JIT compilation phase is time-consuming, such that the dynamic compilation phase will not reduce the execution time. It will even have the inverse effect, which is to say it will require more execution time than if a function which had already been compiled had been used.

### SUMMARY

An illustrative embodiment of the invention allows overcoming these disadvantages of the prior art. Indeed, an embodiment of the invention relates to a method for calling an instance of a function present within at least a first software module and requested by a second software module, referred to as a calling software module.

According to an embodiment of the invention, such a method comprises:
a step for obtaining a current execution context, wherein said current execution context depends on at least one situation of execution of said calling software module and said current execution context comprises execution data;
a step for selecting said instance of function, from at least two available instances, in function of said execution data of said common execution context.

Consequently, an embodiment of the invention allows overcoming the problems related to taking into account multiple software architectures by selecting, when the calling software module is executed, the instance of a function which is able to provide results the quickest. The calling software module may for example be the main application being executed, whereas the first software module may be a dynamic link library or a dynamically loaded library at the start of the execution of the application.

According to one specific embodiment of the application, said step for selection said instance of function comprises:
a step for loading, in an execution environment of said calling software module, a previously built data structure associated to said function and a plurality of execution contexts;
a step for searching, within said built data structure, a reference to said instance of function to be selected depending on said execution data of said common execution context, providing an instance identifier;
a step for identifying, among said at least two instances of said first software module, said instance of function to be selected with the aid of the instance identifier.

Consequently, an embodiment of the invention permits the identification of an instance of a function to be called in function of a data structure, which has been previously built. This prior build consists in the creation of the data structure in function of previously determined execution contexts. These predetermined execution contexts are then used during the execution of the calling software module, to determine which instance of the function that needs to be called.

According to one specific embodiment of the invention, said selection step further comprises, when said search is unsuccessful, a step for selecting a default calling instance.

Consequently, an embodiment of the invention allows overcoming the absence of a context in the data structure associated to said function. Consequently, when the common execution context of the function does not correspond to a pre-calculated context, a default instance of function may be used to permit the application to continue in spite of this. This default instance may perhaps not be the best in terms of performances with respect to the execution context, but it ensures that the application runs without errors.

According to one specific feature of an embodiment of the invention, said current execution context further comprises data relative to:
a hardware architecture of a hardware platform on which said calling software module is executed;
a current workload of said hardware platform on which said calling software module is executed.

Consequently, an embodiment of the invention permits multiple execution situations to be taken into account to determine optimally the current execution context and therefore to select the instance of the function that would best correspond to the current execution context.

According to one specific feature of an embodiment of the invention, said current execution context is translated in the form of execution data which depends on said calling software module and said hardware platform on which said calling software module is executed.

According to one specific feature of an embodiment of the invention, said at least one execution situation of said calling software module comprises a size of problem (n), wherein said size of problem (n) is a parameter of said instance of function selected.

Consequently, an embodiment of the invention permits the instance of function to be called in function of the problem to be resolved by the function. In other terms, an embodiment of the invention makes it possible to select an instance in function of the calling parameter of this function. To illustrate this feature, it is supposed that a function whose function is an integer “i”. The execution context integrates the value of this integer “i” so that for example, if the value of “i” is less than one thousand, a first instance of function will be called and if the value of “i” is greater than or equal to one thousand and less than or equal to two thousand, a second instance of function will be called. If the value of “i” is greater than two thousand, a default calling instance of function may be used. The size of the problem is not restricted however to this specific example. The problem for example may be in the form of a set of parameters, for example in the form of a table. The selection of a particular instance may then be made in function of the size of the different problems of the parameters or the overall size of the set of parameters.

According to one specific embodiment of the invention, said data structure is in the form of a decision tree, in which each node of said decision tree corresponds to a decision to be made in function of at least one of said items of execution data of said common execution context.

According to one specific feature of an embodiment of the invention, the leaves of said decision tree comprise at least one instance identifier of the function to be called.

Consequently, after running through the decision tree, in the step to search for the most suitable instance of function to be executed, an instance of a function identifier is found to indicate to the calling software module (the application) that it is the instance of function that should be used.

According to one specific feature of an embodiment of the invention, when a leaf of said decision tree does not comprise an identifier of an instance of a function to be called, said method comprises a step for selecting an instance of a function to be used by default.

According to one specific feature of an embodiment of the invention, when a leaf of said decision tree does not comprise an identifier of an instance of a function to be called, said method comprises a step for dynamically compiling an instance of a function to be used in function of at least certain items of data of said current execution context.

Consequently, an embodiment of the invention permits the absence of a function adapted to the common execution context to be overcome efficiently, by compiling, when the calling software module is executed, an instance of a function. It may be noted that, unlike the techniques of the prior art, for which this just in time compilation is carried out regardless of the common execution context of the application, an embodiment of the invention, permits the general performances of the application to be improved drastically as this dynamic (also called JIT) compilation step is only used as a last recourse, when the decision tree has not allowed a suitable instance of function to be identified.

According to another aspect, an embodiment of the invention also relates to a method for calculating a decision tree. According to an embodiment of the invention, such a method permits a decision tree to be obtained that is subsequently used in a method for calling an instance of a function as previously described.

According to another aspect, an embodiment of the invention also relates to a method for building a data structure to select an instance of a function to be called when a first software module, referred to as the calling software module, requires the execution of a function by a second software module.

According to an embodiment of the invention, said building method comprises, for a given function:
a step for compiling a plurality of instances of function, wherein each instance is configured so that it has a probable performance in function of at least one determined execution context;
a step for analysing the actual performance of said instances of said plurality of instances of function providing performance indices;
a step for building said data structure associating an instance of a function identifier to a set of data items of an execution context so that said decision structure allows the decision to be made as to which instance of function is to be called in function of said performance indices provided.

According to another aspect, an embodiment of the invention further relates to a device for calling an instance of a function present in at least one first software module and required by a second software module, referred to as the calling software module.

According to an embodiment of the invention, such a device comprises:
means of obtaining a current execution context, wherein said current execution context depends on at least one execution situation of said calling software module and comprises execution data;
means of selecting said instance of function, from at least two available instances, in function of said execution data of said current execution context.

An embodiment of the invention also relates to one or several computer software programmes containing instructions for calling an instance of a function and/or a building method respectively, as described previously. For example, such software programmes may be downloaded from a communication network and/or stored on a support that may be read by a computer and/or executed by a processor.

### BRIEF DESCRIPTION OF THE DRAWINGS

Other features and advantages will become clearer upon reading the following description of a preferred embodiment, provided purely by way of example and in no way restrictively, and the appended drawings, among which:

FIG. 1 presents the general principle of an embodiment of the invention;

FIG. 2 presents a decision tree according to an embodiment of the invention;

FIG. 3 illustrates the process to create a decision tree according to an embodiment of the invention.

### DETAILED DESCRIPTION OF ILLUSTRATIVE EMBODIMENTS

### 1. Reminder of the Principle of an Embodiment of the Invention

As already presented, the efficiency of execution of an application depends heavily on the decisions made upon execution which guide the choice of the resources to be used and the version of code that these resources will use. These decisions are complex as they include a large number of parameters. In other terms the decisions, if the decision (or decision mechanism) is calculated upon execution, is very costly in terms of time and resources. For example, a JIT compiler cannot be asked to produce versions of code for a graphic processor (GPU), a single core processor, a double core processor and then select the best version in function of the context, as such a solution is inefficient as it requires a much longer execution time.

In order to guide the execution of an application in function of the current execution context (the situation in which the application is with respect to the platform as well as the parameters required to execute the function), an embodiment of the invention implements pre-calculated data structures which are integrated into an application which instantiates the decision during execution of an application. The instantiation of the decision consists of deciding which instance of the function that is to be used to enhance the performances. The decision to use one instance instead of another is this made at the execution.

According to an embodiment of the invention, this concerns a different instance of a same function: if a function returns a result “r”, this result “r” will be returned identically by all of the instances of this function. Only the performances to provide this result will be different from one instance to another. The purpose of an embodiment of the invention is not to decide, at the execution, to use one function rather than another, but to use different instance of a same function, which is differentiated by the hardware resources used and their execution time.

A reminder is made that an instance, according to an embodiment of the invention, is a version of a function, presented in an executable form permitting a result to be provided in function of a set of input parameters. This set of parameters may be empty. A function is a set of instructions, written in a programming language, which carries out a certain task and provides a result. A function which does not return any result is a procedure. For simplicity, the term function (and also the term codelet below) is used to designate both functions and procedures.

According to an embodiment of the invention, a data structure is used to decide the instance of function to be used when the application is executed. This data structure uses a current execution context (also called current call context) to identify an instance of a function to be used. The execution context comprises more parameters and items of data than the items of data required to execute the instance of function.

Consequently, it is not just the input data of the instance of function that is used to determine the instance to be used. The input data of the instance of function may be called the “problem” and this problem may have a size. We will see below that the decision to use one or the other instance may depend on the size of the problem (such as for example the length of the input parameters).

An embodiment of the invention thus relates to a method for calling an instance of a function (first, second or nth instance) present in at least one first software module (for example a library which contains the instances) and required by a second software module, called the calling software module (the application). According to an embodiment of the invention, this method comprises:
a step for obtaining a current execution context, which depends at least on at least one execution situation of said calling software module (this is the calling software context) and comprises execution data;
a step for selecting said instance of function, from at least two available instances, in function of the current execution context.

In many cases, the first software module and the second software module will be comprised in the application, such that the application will contain the instances of function; the first and the second software modules will be loaded when it is booted and will be accessible via the application software.

The selection of the instance to be used is, according to an embodiment of the invention, made when the application software is executed and not beforehand during the compilation of the application software. The solution of an embodiment of the invention is therefore adaptive in that the execution decisions are not frozen when the application software is compiled or in function of the choice of the architectures.

An embodiment of the invention permits for example in one case to execute a function on the central processor of the platform (the multi-core processor for example by using the appropriate instance) and in another case, a little later in the execution of the application software on the graphics board (by using the appropriate instance for the execution on the graphics board).

According to an embodiment of the invention, it is also possible, in the case where the data structure does not provide an instance identifier to be used, for example if the data of the current execution context is not suitable for the identification of an instance, to select an “default” instance to permit the execution to be continued.

In another embodiment, it may be cleverly provided to combine the approach of the an embodiment of invention with a dynamic compilation in the absence of an instance of a function for a common execution context.

Consequently, according to this embodiment, if at the end of the data structure path, no instance of function is identified, the method implements a dynamic compilation step of an instance of a function adapted to the common execution context. This dynamic compilation may be implemented in combination with the execution of a default instance. For example, in the case of a multi-core architecture, the default instance is executed on a core, to permit the application to continue its execution while a specific instance is compiled on another core to satisfy the current execution context. Therefore, when the current application context first appears, the default instance is used and an instance that may be used for the current context is compiled and may be inserted into a dynamic library which identifies the instances of the functions.

The data structure identifying the instances associated to the execution contexts is then updated to insert the identifier of the instance that has been dynamically compiled. This new instance may then be used again (without compilation) in the next context execution that refers to it.

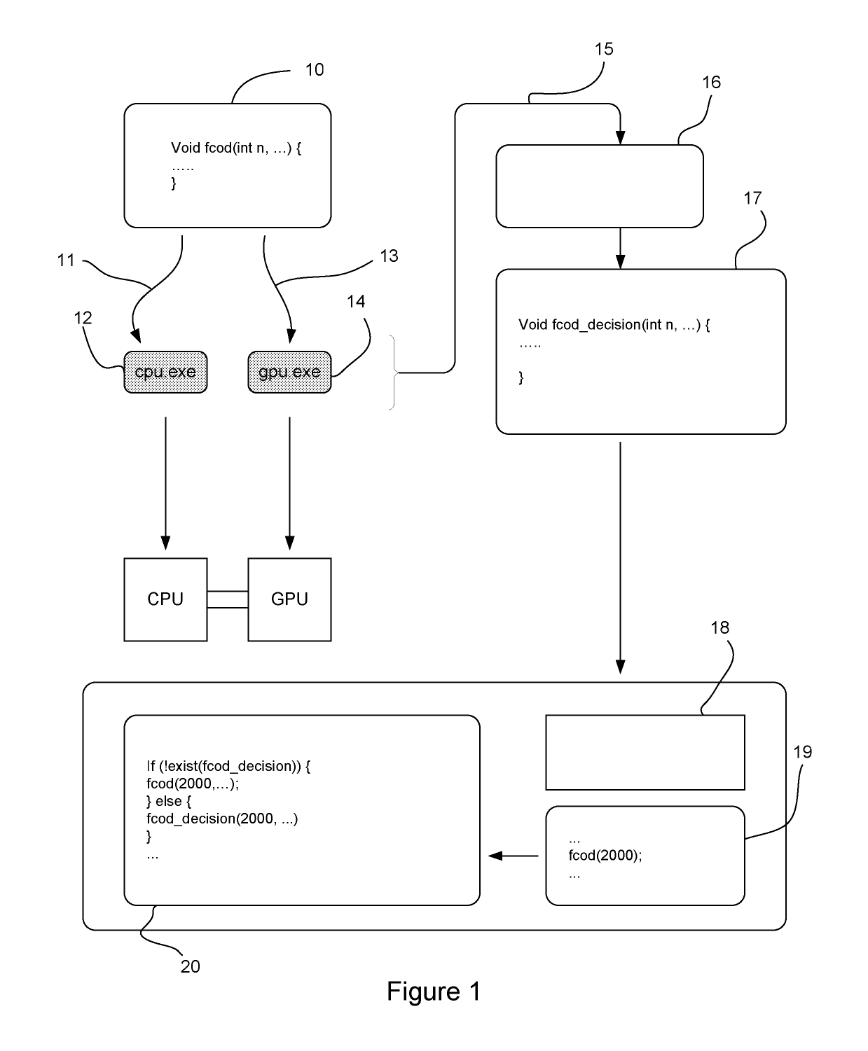

We will describe, in relation to FIG. 1, the general principle of an embodiment of the invention. A function “fcod” 10 is written in a programming language (for example C++). It contains for example a code, in pseudo computer code, of the type:

Void fcod(int n, ...) {
... . .
}

It permits a given task to be carried out. This function 10 is compiled (11) to produce an instance of a function 12 (cpu.exe) designed to be executed on a generalised multi-core processor. It is also compiled (13) to produce an instance of a function 14 (gpu.exe) designed to be executed on a graphic processor. These two instances of function are then inserted (15) in a performance test tool 16 which calculates a decision tree (17). The performance test tool 16 successively executes instances by modifying their input parameters and establishes a performance graph in function of the execution contexts of the tests. These performance measurements allow the decision tree (17) to be calculated, represented here in the form of a “fcod_decision” which permits the decision to be made as to which function to use in function of the execution context. The “fcod_decision” function is for example written, in pseudo computer code, as follows:

Void fcod_decision (int n, ...) {
If (n<1000) {
Use cpu.exe with 1 core
} elseif (number of free cores >= 4 ) {
Use cpu.exe with 4 cores
} elseif (gpu type = = GT800) {
Use gpu.exe
} ... . .
}

When the application is executed, the decision tree is loaded (18). When the “fcod” function has to be called (19: call “fcod” with the parameter 2000), in fact it is the “fcod_decision” function that is called, which returns the instance to be used (12, 14) in function of the execution context. Prior to the “fcod_decision” call, a test (20) is carried out to establish if this “fcod_decision” function exists. If it does not, the default instance is used.

The test 20 may be written in pseudo computer code as follows:

If (!exist(fcod_decision)))
{fcod (2000, ...);
} else {
fcod_decision (2000, ...)
}
...

The “fcod” function call may be replaced by the “fcod_decision” function as after the creation of the decision tree (17), the original code of the application software is modified to replace the call and a new compilation phase of the application software is carried out.

Subsequently, we will especially present the case of the implementation of the method with a multi-core architecture. It is clear however that the invention is not restricted to this specific application.

### 2. Description of an Embodiment

In this embodiment, the implementation of the method with a multi-core architecture is presented.

The use of multi-core architectures supposes that the code of the application has previously been partitioned into sequential sections and into parallel sections.

A main code running on a “master” core launches the execution of sequences of instructions on the other calculation resources. Below, we will call these sequences of instructions “codelets”, which are instances of functions according to an embodiment of the invention. These instances of functions are executed on a core other than the master core.

A codelet is a specific function which respects the following constraints:
the size of the data passed into parameters is known (for example it is the length of the string or the table passed into parameters which defines the size of a problem);
the pointer and table parameters are not aliased (they are not passed by reference);
it does not have direct access to global variables (these variables, if required, are passed into parameters);
the codelet does not produce inputs/outputs (by displaying or waiting for a return from the user);
the calculation of the codelet (the result) is identical for all values of identical parameters (i.e. including the zones pointed by the table and pointer parameters).

These codes may possibly exist in multiple executable versions in order to take into account the heterogeneous nature of the architecture (this is a first category of instances). Furthermore, there are executable versions of codelets specially optimised for certain input data (this is a second category of instances): these executable versions specially optimised for certain input data implement all of the same functions, but may for example be written differently in function of the size N of the input problem. If for example a codelet is in charge of sorting a table of size N, the source code of the codelet may differ according to the size of the table: for a table of size N of less than 100, a first source code would be used to compile a first instance whereas when the size N is greater than 100, a second source code would be used to compile a second instance.

In this embodiment, there are consequently several levels of instances of functions. The execution context of an executable codelet is defined as a set of data comprising at least certain of the following items of data:
the hardware configuration of a calculation node (components for calculations, storing, connections);
the size of the input data of the codelet (the size of the parameters);
the occupation of the calculation cores (calculation units and memory);
the data available in the local core memories;
the rights of use of the node components.

Consequently, the description of a codelet implemented may feature many executable instances, as has already been mentioned, characterised by:
constraints for calling the instance (acceptable parameters);
target architecture of the instance and parameter of the target (number of cores for example);
performance profile of the instance.

The constraints for calling the instance describe the acceptable input data from the point of view of a correct execution. For example, an instance may be implemented for a fixed size of an item of data and be incorrect in the other cases. The usual constraints to which the instances are subjected are as follows:
interval of the size of the items of data;
absence or presence of a required parameter;
interval of the values of certain parameters;
correlation of value between parameters.

The target architectures of the instance are the multi-cores (or part of the multi-cores) which can execute it correctly if the call constraints are respected. The target architectures are described in two parts:
Qualitative: the type of sets of instructions required;
Quantitative: the minimum or maximum number of resources of the resources required. These resources are calculation units or memory units.

The performance profile of the instance is typically a table (or any other suitable description method) which indicates the level of performance reached (for example in Gigaflops) in function of the value of certain input parameters (typically those which indicate the complexity of the problem) in function of the execution resources allocated. For example, this table could have the contents below: for an instance with a parameter N, each performance corresponds to a single or several executable instances which reach the level of performance indicated in the cells:

| | Hardware target | | | | |
|---|---|---|---|---|---|
| | | XY 3 GHz proc. 2 | XY 3 GHz proc. 4 | | |
| | | cores | cores | GPU ZZZ | GPU WWW |
| Parameter N | 1000 | 1 Gigaflop | 0.8 Gigaflops | 0.2 Gigaflops | 0.4 Gigaflops |
| | 1000 | 5 Gigaflops | 9 Gigaflops | 30 Gigaflops | impossible |

The following description according to an embodiment of the invention will describe the two techniques which implement the instances as defined previously.

### 4. Data Structure for Allocating Resources and Associated Instances

An embodiment of the invention introduces a new technique for implementing new instances of functions which have previously been defined. In one specific embodiment of the invention, the instances of functions are selected, when the application is executed, using a data structure whose characteristic is to permit the application to decide the instance to be executed in function of the execution context. This data structure may be for example in the form of a decision tree, but this is not mandatory. It is in return however highly preferable that the structure used permits the instance to be used to be identified rapidly so that one of the advantages provided by an embodiment of the invention, which is to say the introduction of a contexuality of use of an instance of a function, is carried out more rapidly than a dynamic compilation. Consequently, instead of a decision tree, hashing tables or tables with n dimensions may be used, wherein n is the number of constraints of the execution context.

In this embodiment, the decision trees are used. A decision tree in the framework of the use of heterogeneous or homogeneous multi-core architectures permits, according to an embodiment of the invention, the selection during the execution of an application of the instance of a codelet which will provide the best performances, taking into account the execution context, the target architectures and the call constraints. The decision tree is built according to the performance profile and a set of hardware resources available.

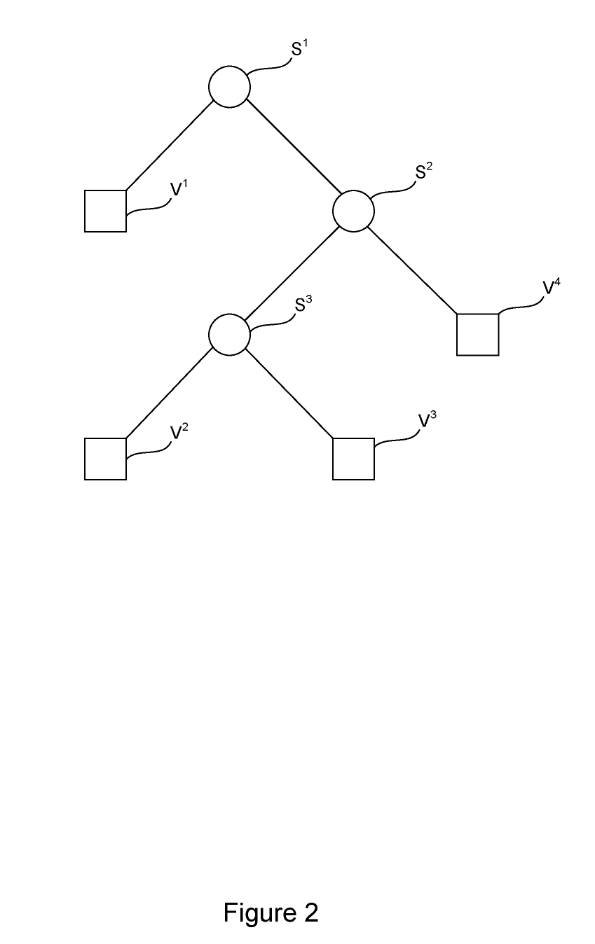

Typically, the decision tree (not necessarily binary) is in the following form (described in relation to FIG. 2).

The circles represent selectors whilst the leaves (squares) represent the instances to be used. A selector chooses the strands of the node to be used. When the strand is a leaf, the corresponding instance is called to execute the instance of the codelet, of which the identifier (the reference) is written in the leaf.

An instance will be used if all of the selectors define the path of the root to the instance. For example, based on the example of the performance profile of the previous section, it is supposed that:
V₁ is the reference of the implementation of the codelet on the XY 3 GHz processor with 2 cores;
V₂ is the reference of the implementation of the codelet on the XY 3 GHz processor with 4 cores;
V₃ is the reference of the implementation of the codelet on the XY 3 GHz processor with 2 cores;
V₄ is the reference of the implementation of the codelet on the GPU ZZ.

Furthermore, it is supposed that at least two cores are always available (allocation of the resources when the application is launched).

The selectors may be as follows:
S₁ is valid: left strand if N is below 10000 otherwise right strand;
S₂ is valid: left strand if GPU ZZ is not available otherwise right strand;
S₃ is valid: left strand if 4 cores are available otherwise right strand.

With this decision tree, if the parameter N (which in this case represents the size/complexity of the problem) is greater than or equal to 1000 and the GPU ZZ is available, the instance V4 will be used to implement the codelet (the identifier of the instance is accessible in the leaves of the tree).

As may be seen on the basis of this example, many versions of the decision tree are possible from the performance profile used.

### 5. Building and Use of Decision Trees

The decision trees may be built manually or automatically from performance profiles. This part is carried out, according to an embodiment of the invention, prior to the building of the binary of the application software which unites the different instances either in the binary or in the (static or dynamic) libraries of the application. This latter possibility is preferable in that it permits the application software to be independent of the instances which may themselves be subject to successive optimisations and be installed for example during updates of the application software.

A decision tree, built for each codelet, is inserted into the code of the application software in place of the call of the codelet. Upon the execution, the decision tree redirects the execution to the instance that is the most suitable for the execution context. The execution context is provided by the application software (value of the parameters, for example the size of the problem or an input parameter table) and by the application software (and/or the operating system) supporting the execution of the application software. For example, the application software keeps the trace of the occupation of material resources and authorises or not the attribution of a resource to a given codelet.

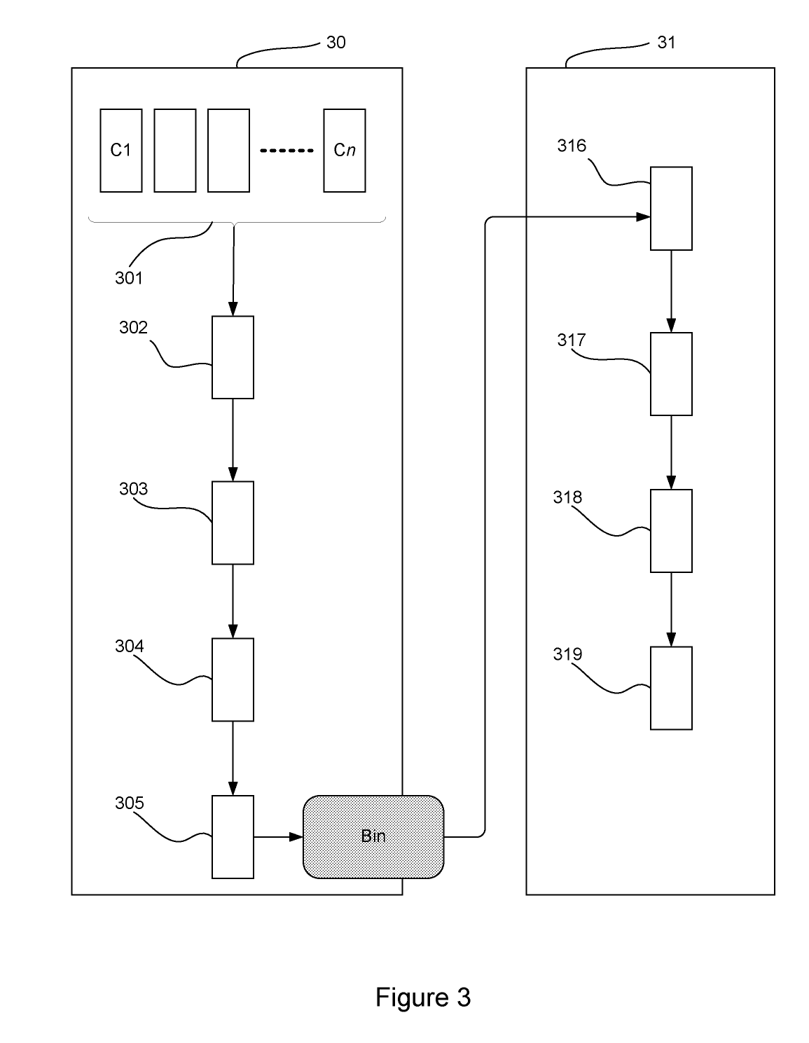

This process is described in relation to FIG. 3, for a given codelet:

In the creation phase of the application software (30):
measurements on the performances of the various hardware targets (C1 to Cn) are carried out (301);
a performance profile is built (302);
from the performance profile the decision tree is built (303);
the decision tree is integrated into the application software by insertion of the corresponding tests in the source code (pre-processing phase —304);
the resulting code is compiled to produce a BIN executable code (with the instances required to implement the codelet) (305);

In, the phase of execution of the application software (31);
the code of the BIN application is executed (316);
if a codelet call is encountered, the decision tree is interpreted or scanned (317);
the instance determined at the end of the interpretation in the decision tree is called (318);
the instance is executed and the check is returned to the application (319).

Consequently, an embodiment of the invention provides an optimal response to the problem of handling multiple architectures by proposing an instance that is adapted to the execution context of the application software.

### 6. Decisional Execution Application

According to one variant, an embodiment of the invention introduces the notion of “decisional execution application”. It is the manager of the applications capable of globally allocating the resources and selecting the adapted codes.

The purpose of a decisional execution application is to dissociate the use of decision trees from the binary code of the application. This permits the process to be adapted after distribution of the applications and to adapt them to new execution contexts which did not exist when the applications were distributed. The “decisional execution application” may thus be distributed in the form of software updates which are carried out automatically.

It is supposed that there is an application software featuring a certain number of codelets (C₁, . . . Cₙ).

The applications may for example be detected by the decisional execution application by a strong hash code on the binary code of the application software and/or when it is compiled, the application software integrates a function capable of indicating its identity clearly. This function may be activated by the decisional execution application.

The process is globally as follows:

1. The application is launched.

2. The application loads and launches the decisional execution application.

3. The decisional execution application identifies the application software.

4. The decisional execution application identifies the configuration of the execution node.

5. The decisional execution application determines the codelets present in the application.

6. The decisional execution application identifies the decision trees integrated.

7. During a codelet call, the application software transfers the control to the decisional execution application which uses the integrated decision trees to choose the variant of the codelet to be used.

8. The decisional execution application returns the control to the application software.

The manner in which the decision trees are integrated into the decisional execution application is varied. For example:
in a configuration file loaded by the decisional execution application;
by access to a local or remote data base;
by integration of the trees into the code of the decisional execution application;
by loading a dynamic library which integrates the trees.

The decisional execution application is therefore especially well adapted to applications software which may need many software updates, either because the application is for example in the test phase and that its performances need to be improved constantly and therefore the decision tree needs to be updated regularly, or because the application software is modular and a user may wish or need to load new modules and in this case use a different decisional execution application software in function of the modules of the application that are installed.

Although the present disclosure has been described with reference to one or more examples, workers skilled in the art will recognize that changes may be made in form and detail without departing from the scope of the disclosure and/or the appended claims.

1. A method comprising:
calling with a processor an instance of a function present within at least a first software module and required by a second software module, referred to as a calling software module, wherein calling comprises:
a step of obtaining a current execution context, wherein said current execution context depends on at least one execution situation of said calling software module, and said current execution context comprises execution data; and
a step of selecting said instance of said function, from at least two available instances, depending on said execution data of said current execution context.

2. The method of claim 1, wherein the step of selecting said instance of said function comprises:
a step of loading, in an execution environment of said calling software module, a previously built data structure associated with said function and a plurality of execution contexts;
a step of searching, within said previously built data structure, a reference to said instance of said function to be selected depending on said execution data of said current execution context, providing an instance identifier; and
a step of identifying, among said at least two instances of said first software module, said instance of said function to be selected with the aid of the instance identifier.

3. The method of claim 2, wherein said step of selecting the instance of said function further comprises, when said step of searching is unsuccessful, a step of selecting a default calling instance of said function.

4. The method of claim 1, wherein said current execution context further comprises data relative to:
a hardware architecture of a hardware platform on which said calling software module is executed; and
a current workload of said hardware platform on which said calling software module is executed.

5. The method of claim 4, wherein said current execution context is translated in a form of execution data which depends on said calling software module and said hardware platform on which said calling software module is executed.

6. The method of claim 1, wherein said at least one execution situation of said calling software module comprises a size of problem (n), wherein said size of problem (n) is a parameter of said instance of said function selected.

7. The method of claim 5, wherein said data structure is in a form of a decision tree, in which each node of said decision tree corresponds to a decision to be made as a function of at least one of said items of execution data of said current execution context.

8. The method claim 7, wherein at least one leaf of said decision tree comprises at least one instance identifier of said function to be called.

9. The method of claim 8, wherein when the at least one leaf of said decision tree does not comprise the at least one instance identifier of said function to be called, said method comprises a step of selecting an instance of said function to be used by default.

10. The method of claim 8, wherein when the leaf of said decision tree does not comprise the at least one instance identifier of said function to be called, said method comprises a step of dynamically compiling an instance of said function to be used as a function of at least certain items of data of said current execution context.

11. A method comprising:
building a data structure by a processor to select an instance of a function to be called when a first software module, referred to as the calling software module, requires execution of said function by a second software module, wherein building comprises, for a given function:
a step of compiling a plurality of instances of said function, wherein each instance is configured so that it has a probable performance as a function of at least one determined execution context;
a step of analysing actual performances of said plurality of instances of said functions providing performance indices; and
a step of building said data structure which associates an instance of a function identifier to a set of data items of an execution context so that said data structure allows a decision to be made as to which instance of said plurality of instances of said function is to be called as function of said performance indices provided.

12. A device for calling an instance of a function present in at least a first software module and required by a second software module, referred to as a calling software module, the device comprising:
means for obtaining a current execution context, wherein said current execution context depends on at least one execution situation of said calling software module and comprises execution data; and
means for selecting said instance of said function, from at least two available instances, as a function of said execution data of said current execution context.

13. A computer-readable memory comprising a computer software program recorded thereon comprising instructions for implementing a calling method for calling an instance of a function when the software program is executed by a processor, wherein the method comprises:
calling with a processor an instance of a function present within at least a first software module and required by a second software module, referred to as a calling software module, wherein calling comprises:
a step of obtaining a current execution context, wherein said current execution context depends on at least one execution situation of said-calling software module, and said current execution context comprises execution data; and
a step of selecting said instance of said function, from at least two available instances, depending on said execution data of said current execution context.

14. A computer-readable memory comprising a computer software program recorded thereon comprising software program code instructions for implementation of a building method for building a data structure when this software program is executed by a processor, wherein the method comprises:
building a data structure by a processor to select an instance of a function to be called when a first software module, referred to as the calling software module, requires execution of said function by a second software module, wherein building comprises, for a given function:
a step of compiling a plurality of instances of said function, wherein each instance is configured so that it has a probable performance as a function of at least one determined execution context;
a step of analysing actual performances of said plurality of instances of functions providing performance indices; and
a step of building said data structure which associates an instance of a function identifier to a set of data items of an execution context so that said data structure allows a decision to be made as to which instance of said plurality of instances of said function is to be called as said function of said performance indices provided.

15. The method claim 6, wherein said data structure is in a form of a decision tree, in which each node of said decision tree corresponds to a decision to be made in function of at least one of said items of execution data of said current execution context.

16. The method of claim 15, wherein at least one leaf of said decision tree comprises at least one instance identifier of a function to be called.

17. The method of claim 16, wherein when the at least one leaf of said decision tree does not comprise the at least one instance identifier of said function to be called, said method comprises a step of selecting an instance of a function to be used by default.

18. The method of claim 16, wherein when the at least one leaf of said decision tree does not comprise the at least one instance identifier of said function to be called, said method comprises a step of dynamically compiling an instance of a function to be used in function of at least certain items of data of said current execution context.
